(19) United States
(12) Patent Application Publication
(10) Pub. No.: US 2025/0227042 A1
(43) Pub. Date: Jul. 10, 2025

(54) METHOD AND APPARATUS FOR MEASURING QUALITY OF EXPERIENCE (QOE) IN WIRELESS COMMUNICATION SYSTEM

(71) Applicant: Samsung Electronics Co., Ltd., Gyeonggi-do (KR)

(72) Inventors: Seungbeom JEONG, Gyeonggi-do (KR); Sangkyu BAEK, Gyeonggi-do (KR); Anil AGIWAL, Gyeonggi-do (KR)

(21) Appl. No.: 18/852,647

(22) PCT Filed: Mar. 10, 2023
(86) PCT No.: PCT/KR2023/003274

§ 371 Date: Sep. 30, 2024

(30) Foreign Application Priority Data
Apr. 20, 2022 (KR) 10-2022-0048836
Aug. 9, 2022 (KR) 10-2022-0099513

(51) Int. Cl. H04L 41/5067; H04W 4/06; H04W 76/20

(52) U.S. Cl. CPC H04L 41/5067; H04W 4/06; H04W 76/20

(57) ABSTRACT

The present disclosure relates to a 5G or 6G communication system for supporting higher data transmission rates. The present disclosure relates to: a communication technique for merging, with IoT technology, a 5G communication system for supporting a data transmission rate higher than that of a 4G system; and a system therefor. The present disclosure can be applied to intelligent services (for example, smart homes, smart buildings, smart cities, smart cars or connected cars, healthcare, digital education, retail businesses, security- and safety-related services, etc.) on the basis of 5G communication technology and IoT-related technology. The present disclosure relates to a method performed by a user equipment for quality of experience (QoE) measurement in a wireless communication system, the method comprising the steps of: receiving configuration information related to the QoE measurement for a multicast broadcast service (MBS); performing the QoE measurement on the basis of the configuration information; and transmitting a QoE measurement result report on the basis of the QoE measurement, wherein the configuration information related to the QoE measurement may include an indicator indicating whether QoE measurement for each MBS session is supported.

### TECHNICAL FIELD

The disclosure generally relates to a wireless communication system and, more particularly, to a method and an apparatus for measuring quality of experience (QoE) in a wireless communication system.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB). Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands. NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In a wireless communication system, a technology for measuring and reporting QoE is required. Particularly, a detailed technology for measuring and reporting QoE related to a multicast broadcast service (MBS) is required.

### DISCLOSURE OF INVENTION

### Technical Problem

Disclosed embodiments provide an apparatus and a method capable of effectively providing a service in a wireless communication system.

### Solution to Problem

According to various embodiments of the disclosure, a method performed by a user equipment (UE) for quality of experience (QoE) measurement in a wireless communication system may include receiving configuration information related to the QoE measurement for a multicast broadcast service (MBS), performing the QoE measurement, based on the configuration information, and transmitting a QoE measurement result report, based on the QoE measurement, and the configuration information related to the QoE measurement may include an indicator indicating whether the QoE measurement for each MBS session is supported.

According to various embodiments of the disclosure, a user equipment (UE) for quality or experience (QoE) measurement may include a transceiver and at least one processor coupled to the transceiver, the at least one processor may be configured to receive configuration information related to the QoE measurement for a multicast broadcast service (MBS), perform the QoE measurement, based on the configuration information, and transmit a QoE measurement result report, based on the QoE measurement, and the configuration information related to the QoE measurement may include an indicator indicating whether the QoE measurement for each MBS session is supported.

According to various embodiments of the disclosure, a method performed by a base station (BS) for quality of experience (QoE) measurement in a wireless communication system may include an operation of transmitting configuration information related to the QoE measurement for a multicast broadcast service (MBS) and an operation of receiving a QoE measurement result report, and the configuration information related to the QoE measurement may include an indicator indicating whether the QoE measurement for each MBS session is supported.

### Advantageous Effects of Invention

Disclosed embodiments provide an apparatus and a method for effectively providing a service in a wireless communication system.

### BRIEF DESCRIPTION OF DRAWINGS

FIG. 1 illustrates an example of a wireless communication system according to embodiments of the disclosure.

FIG. 2 illustrates an example of radio access state transition of a UE in a wireless communication system according to embodiments of the disclosure.

FIG. 3 is a flowchart illustrating a process of configuring and reporting signaling-based quality of experience (QoE) measurement according to embodiments of the disclosure.

FIG. 4 is a flowchart illustrating a process of configuring and reporting management-based quality of experience (QoE) measurement according to embodiments of the disclosure.

FIG. 5 illustrates an example of a transmission and reception procedure between an NG-RAN and the UE in order to support broadcasting of a multicast broadcast service (MBS) according to embodiments of the disclosure.

FIG. 6 illustrates an example of a process for activating or deactivating a configuration or a report on quality of experience (QoE) measurement for each multicast broadcast service (MBS) session according to embodiments of the disclosure.

FIG. 7 illustrates an example of a functional configuration of the UE in a wireless communication system according to embodiments of the disclosure.

FIG. 8 illustrates an example of a configuration of the BS in a wireless communication system according to embodiments of the disclosure.

### MODE FOR CARRYING OUT THE INVENTION

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

The term referring to a signal (for example, message, information, preamble, signal, signaling, sequence, or stream), the term referring to resources (for example, symbol, slot, subframe, radio frame, subcarrier, resource element (RE), resource block (RB), physical resource block (PRB) bandwidth part (BWP), or occasion), the term for a calculation state (for example, step, operation, or procedure), the term referring to data (for example, packet, user stream, information, bit, symbol, or codeword), the term referring to a channel, the term referring to control information (for example, downlink control information (DCI), medium access control element (MAC CE), or radio resource control (RRC) signaling), the term referring to network entities, and the term referring to an interface (for example, N1, N2, N3, or the like) between network entities, the term referring to an element of a device, used in the following description are only examples for convenience of description. Accordingly, the disclosure is not limited to those terms, and other terms having the same technical meanings may be used.

Furthermore, as used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

In the following description of the disclosure, terms and names defined in 5GS and NR standards, which are the latest standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards). Hereinafter, embodiments of the disclosure will be described in detail with reference to the accompanying drawings.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

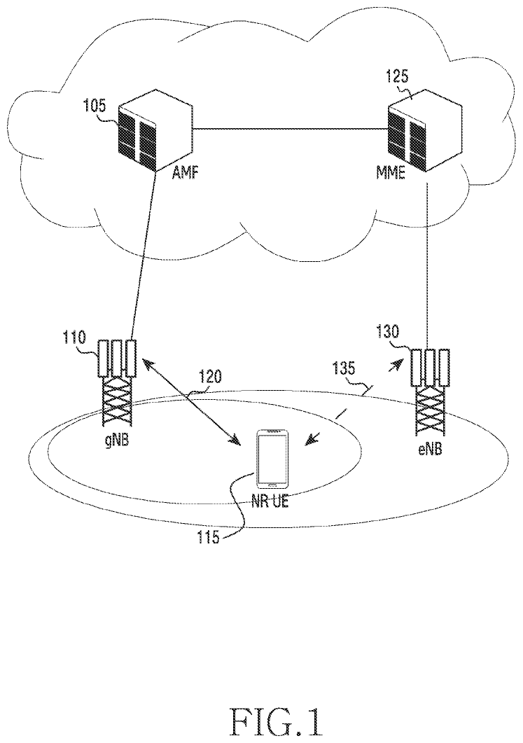

FIG. 1 illustrates an example of a wireless communication system according to embodiments of the disclosure.

Referring to FIG. 1, as illustrated, a radio access network of a next-generation mobile communication system (new radio (NR)) includes a next-generation base station (new radio node B (gNB) or a base station) 110 and an access and mobility management function (AMF) 105. A user equipment (new radio user equipment, hereinafter, referred to an NR UE, a UE, or a terminal) 115 may access an external network through the gNB 110 and the AMF 105. The gNB 110 is a network infrastructure element that provides radio access to the UE 115. The gNB 110 has coverage defined as a predetermined geographical area, based on the distance to which a signal can be transmitted. The gNB 110 may be referred to as an “access point (AP)”, a “5th generation node (5G node)”, a “wireless point”, a “transmission/reception point (TRP)”, or another term having a meaning equivalent thereto, as well as a “base station”.

The UE 115 is a device used by a user and communicates with the gNB 110 through a radio channel. A link from the gNB 110 to the UE 115 or is referred to as a downlink (DL), and a link from the UE 115 or to the gNB 110 is referred to as an uplink (UL). According to circumstances, the UE 115 may be operated without involvement of the user. That is, the UE 115 is a device performing machine type communication (MTC), and may not be carried by the user. The UE 115 may be referred to as a “user equipment (UE)”, a “customer premises equipment (CPE)”, a “mobile station”, a “subscriber station”, a “remote terminal”, a “wireless terminal”, an “electronic device”, a “user device”, or other terms having the equivalent technical meaning, as well as a “terminal”.

In FIG. 1, the gNB 110 may correspond to the evolved Node B (eNB) 130 in the conventional LTE system. The gNB 110 may be connected to the UE 115 through a radio channel and may provide a better service than the eNB 130 as indicated by reference numeral 120. Since all user traffic is served through a shared channel in the next-generation mobile communication system, a device for collecting and scheduling status information, such as buffer statuses, available transmission power statuses, and channel statuses of UEs, is required, and the gNB 110 plays the role. One gNB 110 may control a plurality of cells. Each of the plurality of cells controlled by the gNB 110 may have a bandwidth wider than the conventional maximum bandwidth in order to implement super-high-speed data transmission compared to conventional LTE and may further apply beamforming technology, based on orthogonal frequency division multiplexing (OFDM) as a radio access technology. Further, an adaptive modulation and coding (AMC) scheme of determining a modulation scheme and a channel coding rate in accordance with the channel status of the UE 115 may be applied.

The AMF 105 may perform functions of supporting mobility, configuring bearers, configuring QoS, and the like. The AMF 105 is a device that performs not only the function of managing mobility of the UE 115 but also various control functions and may be connected to a plurality of gNBs. Further, the next-generation mobile communication system may be linked to the conventional LTE system, and the AMF 105 may be connected to an MME 125 through a network interface. The MME 125 may be connected to the eNB 130 which is the conventional base station. The UE 115 supporting LTE-NR dual connectivity may be connected not only to the gNB 110 but also to the eNB 130 and transmit and receive data while as indicated by reference numeral 135.

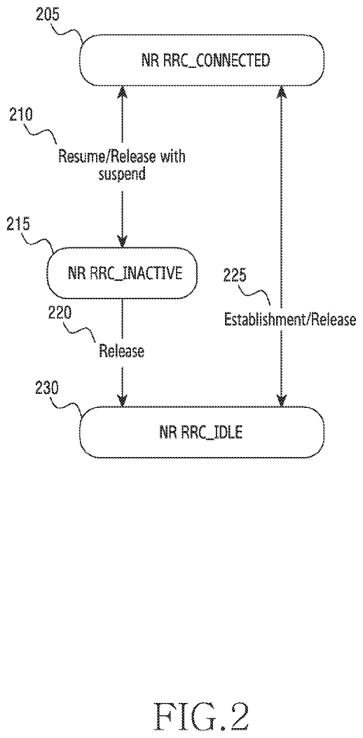

FIG. 2 illustrates an example of radio access state transition of the UE in a wireless communication system according to embodiments of the disclosure.

In the next-generation mobile communication system, the gNB may identify that the UE is in one of the three radio access states (RRC states). The radio access states may include a connected state (RRC-CONNECTED state) 205, an idle state (RRC-IDLE state) 230, and an inactive state (RRC-INACTIVE state) 215. The connected state 205 may be a radio access state in which the UE can transmit and receive data. The idle state 230 may be a radio access state in which the UE monitors whether paging is transmitted to the UE itself. The connected state 205 and the idle state 230 are radio access states applied even to the conventional LTE system, and detailed technologies are the same as those of the conventional LTE system. In the next-generation mobile communication system, the inactive state 215 among the UE states is defined. In the inactive state 215. UE context is maintained in the gNB and the UE, and radio access network (RAN)-based paging may be supported. Characteristics of the inactive state 215 are described below.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to:

The UE in the inactive state 1215 may transition to the connected state 205 or the idle state 230 by using a specific procedure. In operation 210, the UE may transition from the inactive state 215 to the connected state 205 according to a resume process. Further, in operation 210, the UE may transition from the connected state 205 to the inactive state 215 through a release procedure including suspend configuration information. Operation 210 may be performed through transmission and reception of one or more RRC messages between the UE and the gNB, and may include one or more stages. In operation 220, the UE may transition from the inactive state 215 to the idle state 230 through a release procedure after resume. Transition between the connected state 205 and the idle state 230 of the UE follows the conventional LTE technology. That is, in operation 225, the UE may perform the transition between the connected state 205 and the idle state 230 through an establishment or release procedure.

In the next-generation mobile communication system, through a signal (signaling)-based procedure or a management-based procedure, measurement of quality of experience (QoE) of an application layer (App or App layer) of the UE may be activated.

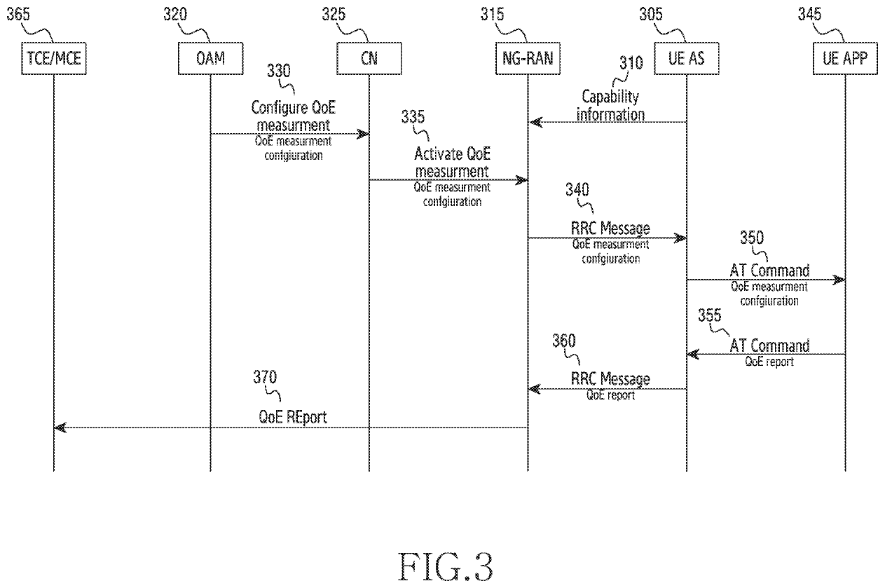

FIG. 3 is a flowchart illustrating a process of configuring and reporting signaling-based quality of experience (QoE) measurement according to embodiments of the disclosure.

In operation 310, an access stratum 305 of the UE may transmit information indicating whether quality of experience (QoE) measurement is supported for each service type to the base station (or NG-RAN) 315 through a UE capability information message. The UE capability information message may include abstract syntax notation one (ASN.1) information and relevant parameter description as shown in the following table.

TABLE 1

| MeasParameters-v1530 ::= | SEQUENCE { | |
|---|---|---|
| [symbol] -r15 | ENUMERATED {supported} | OPTIONAL, |
| [symbol] -r15 | ENUMERATED {supported} | OPTIONAL, |
| ca-IdleModeMeasurements-r15 | ENUMERATED {supported} | OPTIONAL, |
| ca-IdleModeValidityArea-r15 | ENUMERATED {supported} | OPTIONAL, |
| heightMeas-r15 | ENUMERATED {supported} | OPTIONAL, |
| multipleCellsMeasExtension-r15 | ENUMERATED {supported} | OPTIONAL |

} [symbol]
indicates data missing or illegible when filed

qoe-MeasReport
Indicates whether the UE supports QoE Measurement Collection for
streaming services.
qoe-MTSI-MeasReport
Indicates whether the UE supports QoE Measurement Collection for MTSI
services.

Referring to [Table 1], streaming and a multimedia telephony service for IP multimedia subsystem (IMS) (MTSI) service may be supported in LTE. Streaming, an MTSI service, virtual reality (VR), multimedia broadcast multicast services (MBMS), and an extended reality (XR) service may be supported in NR.

In operation 330, operations administration and maintenance (OAM) 320 may provide QoE measurement configuration information to a core network (CN) 325.

In operation 335, the CN 325 receiving the QoE measurement configuration information may activate QoE measurement by transmitting the QoE measurement configuration information to the NG-RAN.

In operation 340, the NG-RAN 315 receiving the QoE measurement configuration information may transmit the QoE measurement configuration information to the UE AS 305 through an RRC message (for example, an RRC connection reconfiguration message). The RRC message may include the following ASN.1 information and relevant parameter description.

TABLE 2

| measConfig [symbol] | | CHOICE{ |
|---|---|---|
| | release | NULL, |
| | setup | SEQUENCE{ |

| | |
|---|---|
| [symbol] -r15 | OCTET STRING (SIZE(1..1000)), |
| [symbol] -r15 | ENUMERATED {qoe, qo [symbol] , spare6, spare5, |

spare4, spare3, spare2, spare1}

| | |
|---|---|
| | } |
| } | OPTIONAL, -- Need ON |

[symbol]

indicates data missing or illegible when filed

measConfigAppLayerContainer
The field contains configuration of application layer measurements, see
Annex L (normative) in TS 26.247 [90] and clause 16.5 in TS 26.114
[99].
serviceType
Indicates the type of application layer measurement. Value qoe indicates
Quality of Experience Measurement Collection for streaming services,
value qoemtsi indicates Enhanced Quality of Experience Measurement
Collection for MTSI.

When the RRC message is a message for setting up the configuration related to QoE measurement, the UE AS 305 may transfer the QoE measurement configuration information to an application layer of the UE (UE APP) 345 through an AT command in operation 350. When the RRC message is a message for releasing the configuration related to QoE measurement, an AT command for deleting the stored configuration information may be transmitted to the UE APP 345. A detailed operation of the UE AS 305 receiving the RRC message may be described below.

TABLE 3
1> if the received otherConfig includes the measConfigAppLayer:

| | |
|---|---|
| 2> | if measConfigAppLayer is set to setup: |
| | 3> forward measConfigAppLayerContainer to upper layers |
| | considering the serviceType; |
| | 3> consider itself to be configured to send application layer |
| | measurement report in accordance with 5.6.19; |
| 2> | else: |
| | 3> inform upper layers to clear the stored application layer |
| | measurement configuration; |
| | 3> discard received application layer measurement report |
| | information from upper layers; |
| | 3> consider itself not to be configured to send application layer |
| | measurement report. |

Although not illustrated in FIG. 3, the UE APP 345 may perform QoE measurement according to the received QoE measurement configuration information. In operation 355, the UE APP 345 may report a result of the QoE measurement to the UE AS 305 through the AT command according to the configuration information.

The UE AS 305 receiving the result of the QoE measurement may report the QoE measurement result to the NG-RAN 315 through an RRC message (for example, MeasReportAppLayer message). The UE AS 305 may use SRB4 to report the QoE measurement result to the NG-RAN 315. The RRC message may include the following ASN.1 information and relevant parameter description.

TABLE 4

| | |
|---|---|
| MeasReportAppLayer-r15 ::= | SEQUENCE { |

| | |
|---|---|
| criticalExtensions | CHOICE { |
| measReportAppLayer-r15 | MeasReportAppLayer-r15-IEs, |
| criticalExtensionsFuture | SEQUENCE ( ) |

}
}

| | |
|---|---|
| MeasReportAppLayer-r15-IEs ::= | SEQUENCE { |

| | | |
|---|---|---|
| [symbol] -r15 | OCTET STRING (SIZE(1..8000)) | OPTIONAL, |

| | |
|---|---|
| [symbol] -r15 | ENUMERATED { [symbol] , [symbol] , spare6, spare5, spare4, spare3, |

spare2, spare1} OPTIONAL,

| | | |
|---|---|---|
| nonCriticalExtension | MeasReportAppLayer-v1590-IES | OPTIONAL |

} [symbol]
indicates data missing or illegible when filed

measReportAppLayerContainer
The field contains container of application layer measurements, see Annex
L (normative) in TS 26.247 [90] and clause 16.5 in TS 26.114 [99].
serviceType
Indicates the type of application layer measurement. Value qoe indicates
Quality of Experience Measurement Collection for streaming services,
value qoemtsi indicates Quality of Experience Measurement Collection for
MTSI.

A detailed procedure of the UE AS 305 reporting the QoE measurement result may be described below.

TABLE 5
A UE capable of application layer measurement reporting in RRC_CONNECTED may initiate the procedure when
configured with application layer measurement, i.e. when measConfigAppLayer has been configured by E-UTRAN.
Upon initiating the procedure, the UE shall:

| 1> | if configured with application layer measurement, and SRB4 is configured, and the UE has received application | |
|---|---|---|
| | layer measurement report information from upper layers: | |
| | 2> | set the measReportAppLayerContainer in the MeasReportAppLayer message to the value of the application |
| | | layer measurement report information; |
| | 2> | set the serviceType in the MeasReportAppLayer message to the type of the application layer measurement |
| | | report information; |
| | | 2> submit the MeasReportAppLayer message to lower layers for transmission via SRB4. |

In operation 370, the NG-RAN 315 may transfer the QoE measurement result report to a final destination (trace collection entity (TCE)) or a measurement collection entity (MCE) 365.

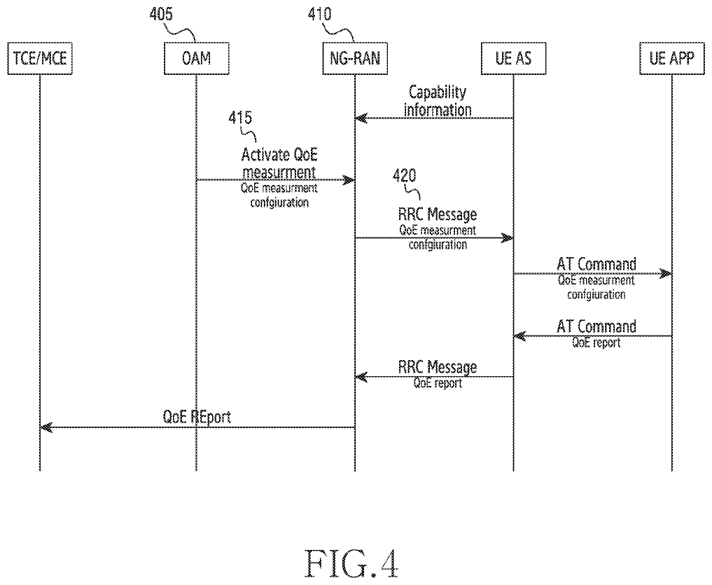

FIG. 4 is a flowchart illustrating a process of configuring and reporting management-based quality of experience (QoE) measurement according to embodiments of the disclosure.

The procedure of configuring the reporting management-based QoE may be similar to the procedure of configuring the reporting signaling-based QoE described in FIG. 3. Accordingly, in FIG. 4 below, detailed description of the same configuration and operation as those of FIG. 3 is omitted. Detailed content for the management-based configuration of FIG. 4 that is omitted may be understood to be the same as the procedure of configuring and reporting signaling-based QoE.

In operation 415, operations administration and maintenance (OAM) 405 directly transmit the QoE measurement configuration to an NG-RAN 410 without passing through a core network (CN), so as to activate QoE measurement in a scheme of configuring and reporting management-based QoE measurement. That is, the OAM 405 may activate the QoE measurement configuration by transmitting the QoE measurement configuration to the NG-RAN 410.

The NG-RAN 410 receiving the QoE measurement configuration from the OAM 405 may search for a single or a plurality of UEs, based on at least one condition (for example, area scope, application layer capability, and service type). Searching for the UE may mean that the NG-RAN 410 selects or identifies the UE.

In operation 420, the NG-RAN 410 may transmit the QoE measurement configuration to each of at least one UE through an RRC message (for example, an RRC connection reconfiguration message). Other procedures and message formats may correspond to the scheme of configuring and reporting signaling-based QoE measurement in FIG. 3.

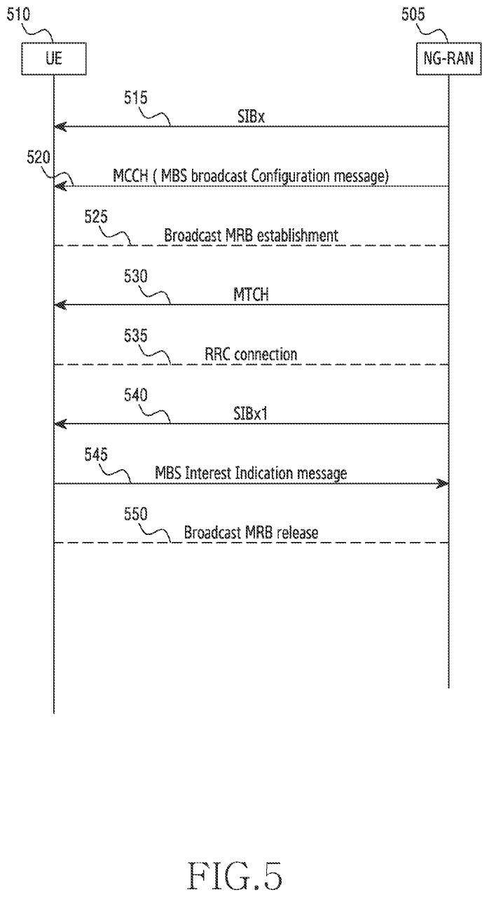

FIG. 5 illustrates an example of a transmission and reception procedure between the NG-RAN and the UE in order to support broadcasting of a multicast broadcast service (MBS) according to embodiments of the disclosure.

In operation 515, a UE 510 in the idle state (RRC_IDLE) or the inactive state (RRC_INACTIVE) may camp on a cell or an NG-RAN 505 that proves SIBx and receive the SIBx. The UE in the connected state (RRC CONNECTED) may also receive the SIBx. The SIBx may include information required for acquiring MBS control channel (MCCH) information that is needed for receiving a multicast broadcast service (MBS) broadcast by the UE. The MCCH has the following meaning. A point-to-multipoint downlink channel used for transmitting MBS broadcast control information associated to one or several MTCH(s) (MBS traffic channel(s)) from the network to the UE. An ASN.1 format of the SIBx may be described below.

TABLE 6
- SIBx
SIBx contains the information required to acquire
the MCCH configuration for MBS broadcast.
SIBx information element

-- ASN1START
-- TAG-SIBX-START
STBX-t17 ::= SEQUENCE {

| ncch-Config-17 | NCCH-Config-r17, | |
|---|---|---|
| cfr-ConfigMCCH-MTCH-r17 | CFR-ConfigMCCH-MTCH-r17, | |
| [symbol] | OCTET STRING | OPTIONAL, |

...

[symbol]

MCCH-Config-r17 ::= SEQUENCE {

| | |
|---|---|
| [symbol] -r17 | [symbol] -r17, |
| [symbol] -r17 | INTEGER (0.. [symbol] ), |
| [symbol] -r17 | ENUMERATED [symbol] , [symbol] , [symbol] , [symbol] , [symbol] , [symbol] , [symbol] , [symbol] |

OPTIONAL, -- NEED

[symbol]

| | |
|---|---|
| [symbol] -r17 | ENUMERATED [symbol] , [symbol] , [symbol] , [symbol] , [symbol] , [symbol] , [symbol] , |

[symbol]

,

[symbol]

, [symbol] , [symbol] , [symbol] , [symbol] ,

[symbol]

, [symbol] ,

[symbol]

[symbol]

[symbol]

-r17 ::= CHOICE {

| | |
|---|---|
| [symbol] -r17 | INTEGER [symbol] ), |
| [symbol] -r17 | INTEGER(0.. [symbol] ), |
| [symbol] -r17 | INTEGER(0.. [symbol] ), |
| [symbol] -r17 | INTEGER(0.. [symbol] ), |
| [symbol] -r17 | INTEGER(0.. [symbol] ), |
| [symbol] -r17 | INTEGER(0.. [symbol] ), |
| [symbol] -r17 | INTEGER(0.. [symbol] ), |
| [symbol] -r17 | INTEGER(0.. [symbol] ), |
| [symbol] -r17 | INTEGER(0.. [symbol] ) |

[symbol]

-- TAG-SIBX-STOP
--ASN1STOP [symbol]
indicates data missing or illegible when filed

SIBx field descriptions

mcch-WindowDuration
Indicates, starting from the slot indicated by mcch-WindowStartSlot, the duration in slot during which MCCH may be
scheduled. Absence of this field means that MCCH is only scheduled in the slot indicated by mcch-WindowStartSlot.
mcch-ModificationPeriod
Defines periodically appearing boundaries, i.e. radio frames for which SFN mod mcch-ModificationPeriod = 0. The contents
of different transmissions of MCCH information can only be different if there is at least one such boundary in-between them.
Value rf2 corresponds to two radio frames, value rf4 corresponds to four radio frames and so on.
mcch-RepetitionPeriodAndOffset
Defines the length and the offset of the MCCH repetition period. rf1 corresponds to a repetition period length of one radio
frame, rf2 corresponds to a repetition period length of two radio frames and so on. The corresponding integer value
indicates the offset of the repetition period in the number of radio frames. MCCH is scheduled in radio frames for which:
SFN mod repetition period length = offset of the repetition period.
mcch-WindowStartSlot
Indicates the slot in which MCCH transmission window starts.

In operation 520, the UE 510 supporting the MBS may acquire an MBSBroadcastConfiguration message in the MCCH when the UE desires to receive (is interested in) the MBS broadcast service, the UE is receiving the MBS broadcast service, or when the UE receives a notification for updating MCCH information after entering a cell that provides the SIBx. This may be described in Rel-17 TS 38.331 as follows.

TABLE 7
5.X.2.3 MCCH information acquisition by the UE
An MBS capable UE interested to or receiving an MBS broadcast service shall:

| 1> | if the procedure is triggered by an MCCH information change notification: | |
|---|---|---|
| | 2> | start acquiring the MBSBroadcastConfiguration message on MCCH from the slot in which the change |
| | | notification was received: |
| 1> | if the UE enters a cell broadcasting SIBx: | |
| | 2> | acquire the MBSBroadcastConfiguration message on MCCH at the next repetition period; |

The update of the MCCH information may be described in Rel-17 TS 38.331 below.

TABLE 8
5.X.1.3 MCCH information validity and notification of changes
Change of MCCH information only occurs at specific radio frames, i.e. the concept of a modification period is used.
Within a modification period, the same MCCH information may be transmitted a number of times, as defined by its
scheduling (which is based on a repetition period).
When the network changes (some of) the MCCH information, it notifies the UEs about the change via PDCCH which
schedules the MCCH in every repetition period in the current modification period.
Upon receiving a change notification, a UE receiving or interested to receive MBS services transmitted using MBS
broadcast acquires the new MCCH information starting from the same slot. The UE applies the previously acquired
MCCH information until the UE acquires the new MCCH information. The notification is transmitted with a 2-bit
bitmap, see TS 38.212 [17] clause 7.3.1.2.1. The MSB in the 2-bit bitmap, when set to ‘1’, indicates the start of MBS
service(s). The LSB in the 2-bit bitmap, when set to ‘1’, indicates modification of MCCH information other than the
change caused by start of new MBS service(s), e.g. modification of a configuration of an on-going MBS session(s),
MBS session(s) stop or neighbouring cell information modification.

The ASN.1 format of the MBSBroadcastConfiguration message may be described below.

TABLE 9
MBSBroadcastConfiguration message

-- ASN1START
-- TAG-MBSBROADCASTCONFIGURATION-START

| | |
|---|---|
| MBSBroadcastConfiguration-17 ::= | SEQUENCE { |
| criticalExtensions | CHOICE { |

| | |
|---|---|
| mbsBroadcastConfiguration-r17 | MBSBroadcastConfiguration-r17-IEs, |

| | |
|---|---|
| criticalExtensionFuture | SEQUENCE { } |

}
}

| MBSBroadcastConfiguration-r17- [symbol] ::= | SEQUENCE { | |
|---|---|---|
| [symbol] r-17 | [symbol] - [symbol] -r17, | |
| [symbol] r-17 | [symbol] - [symbol] -r17 | OPTIONAL, --Need [symbol] |

| | |
|---|---|
| [symbol] -r17 | SEQUENCE (SIZE (1.. [symbol] - [symbol] -r17)) OF [symbol] |

Config [symbol] -r17 OPTIONAL, -- NEED R

| | |
|---|---|
| [symbol] Config [symbol] -r17 | PDSCH-Config [symbol] -r17 |

OPTIONAL, -- Need

[symbol]

| | | |
|---|---|---|
| [symbol] -r17 | [symbol] -r17 | OPTIONAL, -- Need [symbol] |

| | | |
|---|---|---|
| [symbol] | [symbol] | OPTIONAL, |
| [symbol] | SEQUENCE { } | OPTIONAL, |

[symbol]

-- TAG-MBSBROADCASTCONFIGURATION-STOP
-- ASN1STOP [symbol]
indicates data missing or illegible when filed

MBSBroadcastConfiguration field descriptions

pdsch-ConfigMTCH
Provides parameters for acquiring the PDSCH for MTCH. The UE shall use parameters in pdsch-ConfigMCCH also for
PDSCH of MTCH when this field is absent.
mbs-SessionInfoList
Provides the configuration of each MBS session provided by MBS broadcast in the current cell.
mbs-NeighbourCellList
List of neighbour cells providing MBS broadcast services via broadcast MRB. This field is used by the UE together with
mtch-NeighbourCell field signalled for MBS session in the corresponding MBS-SessionInfo. When an empty list is signalled,
the UE shall assume that MBS broadcast services listed in the MBSBroadcastConfiguration message are not provided via
broadcast MRB in any neighbour cell. When the field is absent, the current serving cell does not provide information about
MBS broadcast services in the neighbouring cells, i.e. the UE cannot determine the presence or absence of an MBS service
in neighbouring cells based on the absence of this field.

Referring to the above description, a parameter mbs-sessionInfoList may include information on a plurality of MBS sessions served in the current cell. The ASN.1 format of the parameter rmbs-sessionInfoList may be described below.

TABLE 10

| | |
|---|---|
| MBS-SessionInfoList-r17 ::= | SEQUENCE (SIZE (0..maxNrofMBS-Session-r17)) OF MBS- |

SessionInfo-r17

| | |
|---|---|
| MBS-SessionInfo-r17 ::= | SEQUENCE { |

| [symbol] -r17 | [symbol] -r17, | |
|---|---|---|
| [symbol] -r17 | [symbol] -Value, | |
| [symbol] -ListBroadcast-r17 | [symbol] -List [symbol] -r17 | OPTIONAL, |
| [symbol] -r17 | [symbol] -Config [symbol] -Index-r17 | OPTIONAL, -- |

[symbol]

| | | |
|---|---|---|
| [symbol] -r17 | BIT STRING (SIZE ( [symbol] Cell-MBS-r17)) | OPTIONAL, -- |

[symbol]

| | | |
|---|---|---|
| [symbol] -ConfigIndex-r17 | PDSCH-Config [symbol] -r17 | OPTIONAL, -- |

[symbol]

| | | |
|---|---|---|
| [symbol] -SSB-Mapping [symbol] Index-r17 | [symbol] -SSB-Mapping [symbol] Index-r17 | OPTIONAL -- NEED |

[symbol]

[symbol]

[symbol]

indicates data missing or illegible when filed

Each MBS session may be identified by an MBS session ID corresponding to a temporary mobile group identity (TMGI). The TMGI may include a public land mobile network identifier (PLMN ID) of an operator and a service ID distinguished within the PLMN. A group-RNTI (g-RNTI) may be a radio network temporary identifier (RNTI) that scrambles MTCH transmission and scheduling information.

In operation 525, the UE 510 may perform broadcast MBS radio bearer (MRB) establishment to receive an MBS broadcast session in which the UE is interested. Broadcast MRB establishment may start based on at least one of the following conditions: the case where the MBS session starts, the case where the UE enters a cell that provides the MBS broadcast service in which the UE is interested, the case where interest in the MBS broadcast service is generated, and the case where UE capability limitations that suppresses reception of the MBS broadcast service in which the UE is interested are removed.

In operation 530, the UE 510 may receive MBS broadcast data through an MBS traffic channel (MTCH). The MTCH means as follows: A point-to-multipoint downlink channel for transmitting MBS data of either multicast session or broadcast session from the network to the UE. The UE 510 may decode a physical downlink control channel (PDCCH) scrambled by a group RNTI (g-RNTI) to receive the MTCH. The g-RNTI required for decoding the PDCCH may be included one by one per MBS broadcast session (that is, per mbs-SessionId or per temporary mobile group identity (TMGI)) in a BSBroadcastConfiguration message through an MBS-SessionInfoList IE. A plurality of g-RNTIs may be provided in a list form.

A procedure including operation 525 and operation 530 may be described in Rel-17 TS 38.331 as follows.

TABLE 11
5.X.3.3 Broadcast MRB establishment
Upon a broadcast MRB establishment, the UE shall:

| | |
|---|---|
| 1> | establish a PDCP entity and an RLC entity in accordance with MRB-InfoBroadcast for this broadcast MRB |
| | included in the MBSBroadcastConfiguration message and the configuration specified in 9.1.1.Y; |
| 1> | receive DL-SCH on the cell where the MBSBroadcastConfiguration message was received for the MBS |
| | broadcast service for which the broadcast MRB is established and using g-RNTI and mtch-SchedulingInfo (if |
| | included) in this message for this MBS broadcast service; |
| 1> | configure the physical layer in accordance with the mbs-SessionInfoList, searchSpaceMTCH, pdsch- |
| | ConfigMTCH, applicable for the broadcast MRB, as included in the MBSBroadcastConfiguration message; |
| 1> | inform upper layers about the establishment of the broadcast MRB by indicating the corresponding tmgi: |
| 1> | if an SDAP entity with the received tmgi does not exist: |
| | 2> establish an SDAP entity as specified in TS 37.324 [24] clause 5.1.1. |

In operation 535, the UE 510 may configure an RRC connection with the NG-RAN 505 and transition to the connected state. Alternatively, without operation 535, the UE 510 may be already in the connected state.

In operation 540, the UE 510 may receive SIBx1. SIBx1 may include information on mapping between frequencies and the MBS service. The ASN.1 format of SIBx1 may be described below.

TABLE 12
SIBx1 information element

-- ASN1START
-- TAG-SIBx1-START
SIBx1-r17 ::= SEQUENCE {

| | | |
|---|---|---|
| mbs- [symbol] -IntraFreq-r17 | MBS- [symbol] -List-r17 | OPTIONAL, -- Need [symbol] |
| mbs- [symbol] -InterFreqList-r17 | MBS- [symbol] -InterFreqList-r17 | OPTIONAL, -- Need [symbol] |
| [symbol] CriticalExtension | OCTET STRING | OPTIONAL, |

...
}

| | |
|---|---|
| MBS- [symbol] -List-r17 ::= | SEQUENCE (SIZE (1..max [symbol] -MBS-r17)) OF MBS- [symbol] -r17 |
| MBS- [symbol] -InterFreqList-r17 ::= | SEQUENCE (SIZE (1..maxFreq)) OF MBS- [symbol] -InterFreq-r17 |

MBS- [symbol] -InterFreq-r17 ::= SEQUENCE {

| | |
|---|---|
| [symbol] -CarrierFreq-r17 | [symbol] |
| mbs- [symbol] -List-r17 | MBS- [symbol] -List-r17 |

}
MBS- [symbol] -r17 ::= OCTET STRING [symbol] SIZE [symbol]
-- TAG-SIBx1-STOP
-- ASN1STOP [symbol]
indicates data missing or illegible when filed

SIBx1 field descriptions

mbs-FSAI-InterFreqList
Contains a list of neighboring frequencies including additional bands, if any, that provide MBS services and the
corresponding MBS FSAIs.
mbs-FSAI-IntraFreq
Contains the list of MBS FSAIs for the current frequency. For MBS service continuity, the UE shall use all MBS
FSAIs listed in mbs-FSAI-IntraFreq to derive the MBS frequencies of interest.

The presence of SIBx1 may implicitly activate (enable) reporting of an MBSInterestIndication message described below. The absence of SIBx1 may implicitly deactivate (disable) reporting of an MBSInterestIndication message described below. Although FIG. 5 illustrates that operation 540 is performed after operation 535, the order of operation 535 and operation 540 may be changed.

In operation 545, the UE 510 in the connected state that supports the MBS may transmit the MBSInterestIndication message in order to inform the NG-RAN 505 of the MBS broadcast service that the UE is receiving or in which the UE is interested and a frequency related to the MBS service. Further, the MBSInterestIndication message may be transmitted to transmit priority information of the MBS broadcast compared to unicast. The ASN.1 format of the MBSInterestIndication message may be described below.

```
TABLE 13
    MBSInterestIndication
The MBSInterestIndication message is used to inform network that the UE is receiving/ interested to receive or no
longer receiving/ interested to receive MBS broadcast service(s) via a broadcast MRB.
  Signalling radio bearer: SRB1
  RLC-SAP: AM
  Logical channel: DCCH
  Direction: UE to Network
```

MBSInterestIndication message

-- ASN1START
-- TAG-MBSINTERESTINDICATION-START

| | |
|---|---|
| MBSInterestIndication-r17 ::= | SEQUENCE { |
| criticalExtensions | CHOICE { |
| mbsInterestIndication-r17 | MBSInterestIndication-r17-IEs, |
| criticalExtensionsFuture | SEQUENCE { } |

}
}
MBSInterestIndication-r17-IEs ::= SEQUENCE {

| | | |
|---|---|---|
| mbs-FreqList-r17 | CarrierFreqListMBS-r17 | OPTIONAL, |
| mbs-Priority-r17 | ENUMERATED [symbol] true [symbol] | OPTIONAL, |
| mbs-ServiceList-r17 | MBS-ServiceList-r17 | OPTIONAL |

}
-- TAG-MBSINTERESTINDICATION-STOP
-- ASN1STOP [symbol]
indicates data missing or illegible when filed

MBSInterestIndication field descriptions

mbs-FreqList
List of MBS frequencies on which the UE is receiving or interested to receive MBS broadcast service via a broadcast MRB.
mbs-Priority
Indicates whether the UE prioritises MBS broadcast reception above unicast and MBS multicast reception. The field is
present (i.e. value true), if the UE prioritises reception of all listed MBS frequencies above reception of any of the unicast
bearers. Otherwise the field is absent.
mbs-ServiceList
List of MBS broadcast services which the UE is receiving or interested to receive.

According to the following procedure, the MBSInterestIndication message may be configured and transmitted.

TABLE 14

| | |
|---|---|
| 5.X.4.3 | MBS frequencies of interest determination |

The UE shall:

| 1> | consider a frequency to be part of the MBS frequencies of interest if the following conditions are met: | |
|---|---|---|
| | 2> | at least one MBS session the UE is receiving or interested to receive via a broadcast MRB is ongoing or |

about to start; and

| | |
|---|---|
| NOTE 1: | The UE may determine whether the session is ongoing from the start and stop time indicated in the User |
| | Service Description (USD), see TS 38.300 [2] or TS 23.247 ( [symbol] ). |

| | |
|---|---|
| 2> | for at least one of these MBS sessions [symbol] acquired from the PCell includes for the concerned frequency |

one or more MBS [symbol] as indicated in the USD for this session [symbol] and

| | |
|---|---|
| NOTE 2: | The UE considers a frequency to be part of the MBS frequencies of interest even though NG-RAN may |
| | (temporarily) not employ a broadcast MRB for the concerned session, i.e. the UE does not verify if the |
| | session is indicated on MCCH. |

| | |
|---|---|
| 2> | the supportedBandCombination the UE included in [symbol] -Capability contains at least one band |

combination including the set of MBS frequencies of interest (i.e the UE is capable of simultaneously
receiving broadcast MRBs on the set of MBS frequencies of interest)

[symbol]

| | |
|---|---|
| NOTE 3: | When evaluating whether the UE is capable of simultaneously receiving broadcast MRBs on the set of |
| | MBS frequencies of interest, the UE does not take into account the serving frequencies that it is currently |
| | configured with i.e. the UE only considers MBS frequencies it is interested to receive regardless of |
| | whether these can be received together with the current serving cells or not. |
| 5.X.4.4 | MBS services of interest determination |

The UE shall:

| 1> | consider an MBS service to be part of the MBS services of interest if the following conditions are met [symbol] | |
|---|---|---|
| | 2> | the UE is receiving or interested to receive this service via a broadcast MRB; and |
| | 2> | the session of this service is ongoing or about to start; and |
| | 2> | one or more MBS FSAIs in the USD for this service is included in SIBx1 acquired from the PCell for a |

frequency belonging to the set of MBS frequencies of interest, determined according to 5.x.4.3.

| | |
|---|---|
| NOTE 1: | The UE may determine whether the session is ongoing from the start and stop time indicated in the User |
| | Service Description (USD), see TS 38.300 [2] or TS 23.247 [symbol] |
| 5.X.4.5 | Setting of the contents of MBS Interest Indication |

The UE shall set the contents of the MBS Interest Indication as follows:

| 1> | if the set of MBS frequencies of interest, determined in accordance with 5.x.4.3, is not empty; | |
|---|---|---|
| | 2> | include mbs-FreqList and set it to include the MBS frequencies of interest sorted by decreasing order of |
| | | interest, using the absoluteFrequencySSB for serving frequency, if applicable, and the ARFCN-ValueNR(s) as |
| | | included in SIBx1 (for neighbouring frequencies); |
| | 2> | include mbs-Priority if the UE priorities reception of all indicated MBS frequencies above reception of any |

of the unicast bearers and multicast MRBs;

| | |
|---|---|
| NOTE 1: | If the UE priorities MBS reception and unicast data cannot be supported because of congestion on the |
| | MBS carrier(s). NG-RAN may for example initiate release of unicast bearers. |

| | |
|---|---|
| 2> | if SIBx is scheduled by the PCell: |

| | |
|---|---|
| 3> | include mbs-ServiceList and set it to indicate the set of MBS services of interest sorted by decreasing |

order of interest determined in accordance with 5.x.4.4.

[symbol]

indicates data missing or illegible when filed

In operation 550, the UE 510 may perform broadcast MRB release in order to stop receiving the MBS broadcast. Alternatively, the UE 510 may perform broadcast MBR release, based on at least one of the following condition: the case where the MBS session stops, the case where the UE leaves a cell broadcasting the MBS service in which the UE is interested, the case where interest in the MBS service is lost, and the case where function limitations start prohibiting reception of the corresponding service.

A procedure of the broadcast MRB release may be described below in Rel-17 TS 38.331.

TABLE 15
5.X.3.4 Broadcast MRB release
Upon broadcast MRB release for MBS broadcast service, the UE shall:

| | |
|---|---|
| 1> | release the PDCP entity, RLC entity as well as the related MAC and physical layer configuration; |
| 1> | inform upper layers about the release of the broadcast MRB by indicating the corresponding tmgi; |
| 1> | if the SDAP entity associated with the corresponding tmgi has no associated MRB [symbol] |
| | 2> release the SDAP entity, as specified in TS 37.324 [24] clause 5.1.2. |

[symbol]

indicates data missing or illegible when filed

At the NR 3GPP standards meeting, the RAN2 and RAN3 working groups reached the following agreement on Release 17 (Rel-17).

That is, it was agreed that QoE measurement of the UE in the idle state (RRC_IDLE) or the inactive state (RRC_INACTIVE) for the MBS service is not supported in Rel-17. However, in Rel-18, the content indicating that QoE measurement of the UE can be supported (at least for MBS broadcast, and not yet determined for MBS multicast) is included in Rel-18 WID.

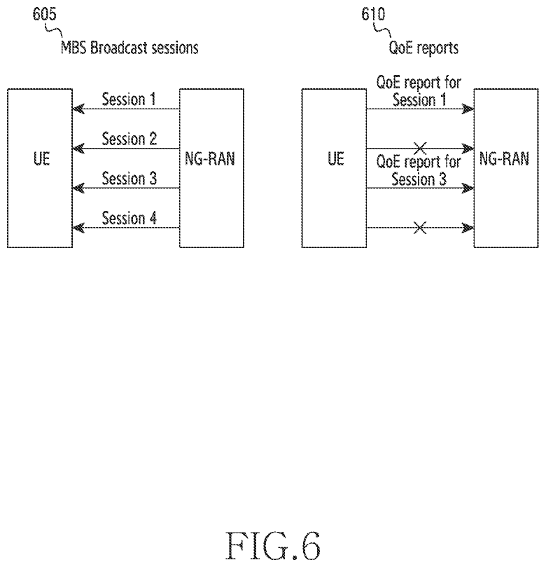

FIG. 6 illustrates an example of a process for activating or deactivating a configuration or a report on quality of experience (QoE) measurement for each multicast broadcast service (MBS) session according to embodiments of the disclosure.

The QAM or the NG-RAN may configure QoE measurement of the UE for the MBS service. In the NG-RAN or the cell, a plurality of MBS (broadcast) sessions may exist. In this case, the OAM or the NG-RAN may desire to support QoE measurement only for a specific MBS session. For example, as indicated by reference numeral 605, the NG-RAN may provide a service to a total of four MBS sessions. However, it can be burdensome in terms of resources and energy usage for the UE to perform QoE measurement for all MBS sessions and generate and transmit a report on the QoE measurement result. Further, from a viewpoint of the OAM or the NG-RAN, receiving and processing the QoE report for all MBS sessions from the UE may be burden in terms of computing, processing, and resources. There may be MBS sessions (for example, session 1 and session 3 in FIG. 6) that the OAM or the NG-RAN desires to improve the quality of service by receiving the report on the QoE measurement result and optimizing the network. On the other hand, there may be MBS sessions (for example, session 2 and session 4 in FIG. 6) for which the OAM or the NG-RAN does not desire to receive the QoE report. For example, the NG-RAN may desire to activate (enable) the QoE measurement and report of the UE for the MBS session for which the high quality of service is required or the service is received by many users. Unlike this, the NG-RAN may desire to not activate (disable) the QoE measurement and report of the UE for the MBS session for which service requirements are low or the service is received by a few UEs. Accordingly, as indicated by reference numeral 610, the OAM or the NG-RAN may activate the QoE measurement or report only for session 1 and session 3 and deactivate the same for session 2 and session 4.

According to an embodiment, the UE may report whether QoE measurement for the MBS service is supported to the NG-RAN. For example, the UE may report whether QoE measurement for the MBS service is supported through an indicator (an indicator indicating whether QoE measurement for the MBS service is supported). The indicator indicating whether QoE measurement for the MBS service is supported may be included in a message (for example, a UECapability message) for UE capability information. The UE may transmit the UECapability message including the indicator indicating whether QoE measurement for the MBS service is supported to the NG-RAN.

According to an embodiment, the UE may report whether QoE measurement for each MBS session is supported to the NG-RAN. An indicator that indicates whether QoE measurement for each MBS session is supported (an indicator indicating whether QoE measurement for each MBS session is supported) may be defined within the UECapability message (that is, the indicator indicating whether QoE measurement for each MBS session is supported may be included within the UECapability message) and reported from the UE to the NG-RAN. At this time, the indicator indicating whether QoE measurement for each MBS session is supported may be defined separately from the indicator indicating whether QoE measurement for the MBS service is supported. In other words, the indicator indicating whether QoE measurement for each MBS session is supported may be defined as a field separately from the indicator indicating whether QoE measurement for the MBS service is supported, and included within the UECapability message. Alternatively, the indicator indicating whether QoE measurement for each MBS session is supported and the indicator indicating whether QoE measurement for the MBS service is supported may be defined as one field. For example, through a 2-bit field indicating whether QoE measurement for each MBS session is supported and QoE measurement for the MBS service is supported, it may be indicated whether QoE measurement for each MBS session and whether QoE measurement for the MBS service is supported.

According to an embodiment, the NG-RAN may transmit an indicator indicating whether QoE measurement for each MBS session (or application layer measurement of the UE) is activated to the UE through MBSBroadcastConfiguration, a system information message, or a newly broadcast message. When the indicator indicating whether QoE measurement is activated is included in the MBSBroadcastConfiguration message, the indicator indicating whether QoE measurement is activated (for example, appLayerSupport) may be included within the MBSBroadcastConfiguration message for each MBS-SessionInfo as follows.

TABLE 16

| MBS-SessionInfoList-r17 ::= | SEQUENCE (SIZE [symbol] OF MBS-SessionInfo-r17 | |
|---|---|---|
| MBS-SessionInfo-r17 ::= | SEQUENCE { | |
| [symbol] -r17 | [symbol] -r17, | |
| [symbol] -r17 | [symbol] | |
| [symbol] | [symbol] | [symbol] |
| [symbol] -ListBroadcast-r17 | [symbol] -ListBroadcast-r17 | OPTIONAL, |
| [symbol] -SchedulingInfo-r17 | DRX- [symbol] | OPTIONAL,-- NEED [symbol] |
| [symbol] -NeighbourCell-r17 | BIT STRING (SIZE(maxNeighCell-MBS-r17)) | OPTIONAL,-- NEED [symbol] |
| pdsch-ConfigIndex-r17 | PDSCH-ConfigIndex-r17 | OPTIONAL, -- NEED [symbol] |
| [symbol] Index-r17 | [symbol] | OPTIONAL -- NEED [symbol] |

} [symbol]
indicates data missing or illegible when filed

At this time, the TMGI or the g-RNTI (for example, within the same MBS-SessionInfo) transmitted along with the indicator indicating whether QoE measurement is activated may be used to indicate a specific MBS session(s). Through the indicator indicating whether QoE measurement is activated, the QoE measurement or report for the specific MBS session(s) indicated by the TMGI or the g-RNTI may be activated or deactivated.

According to an embodiment, the indicator indicating whether QoE measurement is activated may be defined as “ENUMERATED {enabled, disabled}”. The indicator indicating whether QoE measurement is activated is an optional IE and may be included in MBS-SessionInfo. In this case, the NG-RAN supporting QoE measurement (or the NG-RAN supporting QoE measurement for the MBS or the NG-RAN supporting QoE measurement for each session) may configure to include the indicator indicating whether QoE measurement is activated in MBS-SessionInfo. The NG-RAN may configure the indicator indicating whether QoE measurement is activated as true or enable for a session for which QoE measurement is to be activated or may configure the indicator as false or disable for a session for which QoE measurement is to be deactivated. The NG-RAN which does not support QoE measurement (or the NG-RAN which does not support QoE measurement for the MBS or the NG-RAN which does not support QoE measurement for each session) may configure not to include the indicator indicating whether QoE measurement is activated in MBS-SessionInfo.

According to another embodiment, the indicator indicating whether QoE measurement is activated may be defined as “ENUMERATED {enabled}”. The indicator indicating whether QoE measurement is activated may be included as an optional IE.

According to an embodiment, a radio resource control (RRC) layer or an access stratum (AS) layer of the UE receiving the indicator indicting whether QoE measurement is activated may transfer the indicator indicating whether QoE measurement is activated to an application layer (APP layer) of the UE (Option 1). The UE may transfer a corresponding TMGI value to a higher layer (or the APP layer) after the broadcast MRB is established in operation 525 of FIG. 5. At this time, the indicator (for example, appLayerSupport) indicating whether QoE measurement is activated may be transmitted together or separately.

TABLE 17
5.X.3.3 Broadcast MRB establishment
Upon a broadcast MRB establishment, the UE shall:

| | |
|---|---|
| 1> | establish a PDCP entity and an RLC entity in accordance with MRB-InfoBroadcast for this broadcast MRB included in |
| | the MBSBroadcastConfiguration message and the configuration specified in 9.1.1.Y; |
| 2> | receive DL-SCH on the cell where the MBSBroadcastConfiguration message was received for the MBS broadcast |
| | service for which the broadcast MRB is established and using g-RNTI and mtch-SchedulingInfo (if included) in this |
| | message for this MBS broadcast service; |
| 1> | configure the physical layer in accordance with the mbs-SessionInfoList, searchSpaceMTCH, pdsch-ConfigMTCH, |
| | applicable for the broadcast MRB, as included in the MBSBroadcastConfiguration message; |
| 1> | inform upper layers about the establishment of the broadcast MRB by indicating the corresponding [symbol] |
| | [symbol] |
| 1> | if an SDAP entity with the received [symbol] does not exist [symbol] |
| | 2> establish an SDAP entity as specified in TS 37.324 [24] clause [symbol] |

[symbol]

indicates data missing or illegible when filed

Alternatively, instead of the TMGI, a corresponding g-RNTI along with the indicator indicating whether QoE measurement is activated may be transferred to the APP layer of the UE. The existing AT-command may be used or a new AT-command may be defined and used to transfer the indicator indicating whether QoE measurement is activated, the TMGI, or the g-RNTI to the APP layer of the UE by the RRC layer of the UE. The APP layer receiving the indicator indicating whether QoE measurement is activated may apply and use the indicator indicating whether QE measurement is activated to MBS session(s) corresponding to the received TMGI (or g-RNTI). For example, when the indicator indicating whether QoE measurement is activated is configured as true or enable or is present, the APP layer of the UE may perform QoE measurement and generate the QoE measurement report only for MBS session(s) in which the indicator indicating whether QoE measurement is activated is configured. In another example, the APP layer may always perform QoE measurement and generate the QoE measurement report for all MBS sessions. However, only for MBS session(s) to which the indicator indicating whether QoE measurement is activated is applied, the QoE measurement report may be transferred to the AS layer of the UE. For example, the APP layer of the UE always performs QoE measurement for all MBS sessions, but may generate the QoE measurement report and transfer the same to the AS layer only for MBS session(s) to which the indicator indicating whether QoE measurement is activated is applied.

On the other hand, when the indicator indicating whether QoE measurement is activated is configured as false or disable or is absent, the APP layer of the UE may not perform QoE measurement and not generate the QoE measurement report for MBS session(s) to which the indicator indicating whether QoE measurement is activated is applied. In another example, the APP layer of the UE may always perform QoE measurement and generate the QoE measurement report for all MBS sessions, but may not transfer the QoE measurement report to the AS layer of the UE or discard the same only for MBS session(s) to which the indicator indicating whether QoE measurement is activated is applied. For example, the APP layer of the UE always performs QoE measurement for all MBS sessions, but may not generate the QoE measurement report only for MBS session(s) to which the indicator indicating whether QoE measurement is activated is applied.

According to another embodiment, the AS layer of the UE may not transfer the indicator indicating whether QoE measurement is activated to the APP layer of the UE, and may filter the QoE measurement result report received from the APP layer, based on the indicator indicating whether QoE measurement is activated (Option 2). That is, when receiving the QoE measurement result report of the APP layer of the UE, the AS layer of the UE may identify an MBS session that generated the report. To this end, the AS layer of the UE may receive a TMGI or a g-RNTI indicating specific MBS session(s) along with the QoE measurement result report from the APP layer of the UE. When the indicator (for example, appLayerSupport) indicating whether QoE measurement is activated that the AS layer of the UE received from the NG-RAN is configured as true or enable or is present, the AS layer of the UE may transfer only the QoE measurement report (received from the APP layer) generated by the MBS session corresponding thereto to the NG-RAN. When the indicator (for example, appLayerSupport) indicating whether QoE measurement is activated that the AS layer of the UE received from the NG-RAN is configured as false or disable or is absent, the AS layer of the UE may not transfer the QoE measurement report generated by the MBS session corresponding thereto to the NG-RAN or discard the same even though the AS layer receives the QoE measurement report.

According to an embodiment, the NG-RAN may transmit configuration information of QoE measurement (or application layer measurement of the UE) for each MBS session to the UE. For example, the NG-RAN may transmit configuration information of QoE measurement (or application layer measurement of the UE) for each MBS session to the UE through MBSBroadcastConfiguration. Alternatively, the NG-RAN may transmit configuration information of QoE measurement (or application layer measurement of the UE) for each MBS session to the UE through a system information message. Alternatively, the NG-RAN may transmit configuration information of QoE measurement (or application layer measurement of the UE) for each MBS session to the UE through a newly defined broadcast message. That is, the OAM or the NG-RAN may set a different QoE measurement configuration for each MBS session in the UE. For example, as indicated by reference numeral 610, the QoE configuration for session 1 and the QoE configuration for session 3 may be different. For example. QoE measurement configuration information may be included in an MBSBroadcastConfiguration message for each MBS-SessionInfo as follows.

TABLE 18

[symbol]

[symbol]

indicates data missing or illegible when filed

Some or all of the following parameters may be included as QoE measurement configuration information for each MBS session. That is, the QoE measurement configuration information for each MBS session may include at least one of the following parameters.
QoE configuration ID (for example, measConfigAppLayerId): indicates an identifier (ID) of QoE configuration information and may be used for distinguishing a plurality of QoE configurations. The UE includes the QoE configuration ID when measuring the corresponding MBS session according to QoE measurement configuration information and transmitting the generated QoE report, and thus may indicate QoE measurement configuration information that generates the QoE report.
Application layer QoE configuration information (for example, measConfigAppLayerContainer): may include information required for performing QoE measurement for the corresponding MBS session by the application layer of the UE. The Application layer QoE configuration information may be received (or defined) in an OCTET STRING form in the RRC message.
Pause/Resume indicator (for example, pauseReporting): may be an indicator used for temporarily pausing the QoE measurement report of the corresponding MBS session when the NG-RAN is overload. For example, the NG-RAN configures the pause/resume indicator as true in order to indicate pause of the QoE measurement report or is present, and may transmit the pause/resume indicator to the UE. Further, when overload of the NG-RAN is resolved, the NG-RAN may use the pause/resume indicator to resume the paused QoE measurement report of the corresponding MBS session. For example, in order to indicate resume of the QoE measurement report, the NG-RAN may configure the pause/resume indicator as false or, when the pause/resume indicator is absent and may transmit the same to the UE.
Indicator indicating whether MBS session start and end are reported (for example, transmissionOfSessionStartStop): when the NG-RAN configures an indicator indicating whether the MBS session start and end are reported (for example, configures the indicator as true or the indictor is present), the UE may report the start and end of reception of the corresponding MBS session to the NG-RAN through the QoE measurement report (for example, through an appLayerSessionStatus indicator) when starting and ending the reception of the corresponding MBS session. When the NG-RAN does not configure the indicator indicating whether the MBS session start and end are reported (for example, configures the indicator as true or the indicator is present), the UE may not perform the report.
Indicator indicating whether MBS session start and end are reported (for example, transmissionOfSessionStartStop): when the NG-RAN configures an indicator indicating whether the MBS session start and end are reported (for example, configures the indicator as true or the indictor is present), the UE may report the start and end of the QoE measurement session of the corresponding MBS session through the QoE measurement report (for example, through an appLayerSessionStatus indicator) when starting and ending the QoE measurement session of the corresponding MBS session. When the NG-RAN does not configure the indicator indicating whether the QoE session start and end are reported (for example, configures the indicator as true or the indictor is present), the UE may not perform the report.
RAN visible QoE measurement period (for example, ran-VisiblePeriodicity): the NG-RAN may indicate a period of RAN visible QoE measurement for the corresponding MBS session through RAN visible QoE measurement period information. Based on the corresponding period, the UE may perform QoE measurement. The corresponding period may be a sampling period of QoE measurement data.
RAN visible QoE measurement report period (for example, ran-VisiblePeriodicity): the NG-RAN may indicate a period of reporting RAN visible QoE measurement for the corresponding MBS session through RAN visible QoE measurement report period information. The UE may report at once one or more RAN visible QoE measurement values sampled according to the RAN visible QoE measurement report period or based on a sampling period (for example, the sampling period may be configured to be shorter than the report period).
The maximum number of buffer sizes that can be reported at once: may indicate the maximum number of stored data buffer sizes that can be reported for the corresponding MBS session. When reporting data buffer sizes for the corresponding MBS session, the UE may report at once a plurality of buffer sizes that is equal to or smaller than the maximum number of reportable buffer sizes.
Initial service playout delay (for example, reportPlayoutDelay ForMediaStartup): may indicate an indicator indicating reporting of a time spent for starting first receiving the service for the corresponding MBS service by the UE. When the corresponding indicator is configured (for example, is configured as true or is present), the UE may report, to the NG-RAN, a time spent for starting first receiving the service for the corresponding MBS session by the UE. When the corresponding indicator is not configured (for example, is configured as false or is absent), the UE may not report, to the NG-RAN, the time spent for starting first receiving the service for the corresponding MBS session by the UE.

When the NG-RAN transmits a message including some or all of the defined parameters (for example, QoE measurement configuration information) or indicates at least one of the defined parameters to the UE, it may mean to indicate activation of QoE measurement for each MBS session to the UE. Based on QoE measurement configuration information, the UE may perform the QoE measurement or report for each MBS session. Unlike this, when the NG-RAN does not indicate the defined parameters within the message or the message which the NG-RAN transmits to the UE does not include the defined parameters, it may mean to indicate deactivation of the QoE measurement for each MBS session, and the UE may not perform the QoE measurement or report for each MBS session.

According to another embodiment, the indicator indicating whether QoE measurement for each MBS session is performed may be included not only in a broadcast message but also a dedicated message transmitted for each UE. When the broadcast message is used, the indicator indicating whether QoE measurement is activated may be commonly applied to all UEs for each MBS session. On the other hand, when the UE-dedicated message is used, the indicator may be differently configured for every UE for each MBS session. For example, the OAM or the NG-RAN may configure the QoE measurement or report for MBS session 1 and MBS session 3 in UE 1 and configure the QoE measurement or report for MBS session 2 and MBS session 3 in UE 2 at the same time. QoE configuration information may be included in an RRCReconfiguration message or an RRCResume message (that is, a dedicated message) in an AppLayerMeasConfig format. However, the UE-dedicated message described above is only an example, and embodiments of the disclosure are not limited thereto. For example, QoE configuration information may be included in a UE-dedicated message such as an RRCRelease message, an RRCReestablishment message, a UEAssistanceInformation message, or a UEInformationRequest message (for example, in an AppLayerMeasConfig format). In addition to the QoE configuration information, the indicator indicating whether QoE measurement for each MBS session is performed may be transmitted as follows.

TABLE 19

[symbol]

[symbol]

indicates data missing or illegible when filed

According to an embodiment, a plurality of pieces of MeasConfig AppLayer (QoE configuration information) may be included in AppLayerMeasConfig. For each MeasConfig AppLayer, a QoE configuration information ID (measConfigAppLayerId), APP layer QoE configuration information (measConfigAppLayerContainer), and a service type (serviceType) of QoE configuration information may be included. As shown in the above table, the MBS may be additionally defined in serviceType. Alternatively. MBS broadcast and MBS multicast may be separately defined in serviceType. When serviceType is configured as the MBS or the MBS broadcast, the NG-RAN support QoE measurement, the NG-RAN supports QoE measurement for the MBS, or the NG-RAN supports QoE measurement for each MBS session, the indicator (for example, mbs-SessionList) indicating whether QoE measurement for each MBS is performed may be included in MeasConfigAppLayer. The indicator indicating whether QoE measurement for each MBS is performed may include a plurality of TMGIs or g-RNTIs in order to indicate a plurality of MBS sessions that requires QoE measurement. Further, the indicator indicating whether QoE measurement for each MBS is performed may include at least one TMGI or g-RNTI in order to indicate at least one MBS session that requires QoE measurement. For a plurality of MBS sessions (or at least one MBS session) included in the list, the UE may perform the QoE measurement or report. On the other hand, for at least one MBS session that is not included in the corresponding list, the UE may not perform the QoE measurement or report. As described above, the indicator indicating whether QoE measurement is performed may be transferred from the RRC layer or the AS layer of the UE to the App layer of the UE, and the App layer of the UE may measure QoE, based on the indicator and report the measurement result to the AS layer of the UE. Alternatively, the AS layer of the UE may filter the QoE measurement result report received from the App layer without transferring the indicator indicating whether QoE measurement is performed to the App layer of the UE.

When serviceType is not the MBS or MBS broadcast, the NG-RAN may not support QoE measurement, NG-RAN may not support QoE measurement for the MBS, or the NG-RAN does not support QoE measurement for each session, the indicator indicating whether QoE measurement is performed may be absent.

According to an embodiment, for each MeasConfigAppLayer, an indicator (for example, mbs-SessionId) indicating one MBS session may be included in MeasConfigAppLayer. For example, the following ASN.1 format may be defined.

TABLE 20

[symbol]

[symbol]

indicates data missing or illegible when filed

An indicator indicating one MBS session for each MeasConfigAppLayer may be defined by one TMGI or g-RNTI in order to indicate one MBS session that requires QoE measurement. That is, for each MBS session, different QoE configuration information (for example, parameters such as measConfigAppLayerId and measConfigAppLayerContainer included in MeasConfigAppLayer) may be configured. Accordingly, the UE may perform different QoE measurement for each MBS session and generate different QoE measurement reports. In order to distinguish QoE measurement reports generated by different QoE configuration information for each MBS session, when reporting the QoE measurement, the UE may report an RRC message (for example, MeasurementReportAppLayer) or an application layer report container (for example, measConfigAppLAyerContainer) including an MBS session ID. Alternatively, the OAM and/or the NG-RAN, and/or the UE may pre-store/define mapping information between the MBS session ID and measConfigAppLayerId. Accordingly, when reporting the QoE measurement, the UE may indicate measConfigAppLayerId instead of the MBS session ID, the NG-RAN or the OAM may identify the mapped MBS session ID.

According to an embodiment, information for indicating at least one MBS session for each MeasConfigAppLayer (for example, for each measConfigAppLayer ID) may be included in MeasConfigAppLayer. At this time, information for indicating each MBS session may include an indicator (for example, mbs-SessionId) indicating the MBS session and application layer configuration information (for example, measConfigAppLayerContainer-rxx). For example, the following ASN.1 format may be defined.

TABLE 21

[symbol]

[symbol]

indicates data missing or illegible when filed

In order to indicate one MBS session that requires QoE measurement for each MBS session, mbs-SessionId may be defined by one TMGI or g-RNTI. Further, the measConfigAppLayerContainer-rxx may include application layer measurement information for the corresponding MBS session. That is, a plurality of MBS session Ids and application layer measurement information corresponding thereto (corresponding to the number thereof) may be included in one QoE configuration ID (for example, measConfigAppLayerId). At this time, conventional measConfigAppLayerContainer-r17 may be omitted. Accordingly, the UE may perform different QoE measurement for each MBS session and generate different QoE measurement reports. In order to distinguish QoE measurement reports generated by different QoE configuration information for each MBS session, when reporting the QoE measurement, the UE may report an RRC message (for example, MeasurementReportAppLayer) or an application layer report container (for example, measConfigAppLAyerContainer) including an MBS session ID.

MBS QoE configuration information for the UE in the RRC_INACTIVE or RRC_IDLE state may be transmitted while being included in a dedicated RRC message (for example, RRCRelease or a newly defined message). An indicator indicating whether QoE measurement is performed may be included in the dedicated RRC message. The AS layer of the UE receiving the indicator may transfer the same to the APP layer like in Option 1, and the APP layer may activate/deactivate the QoE measurement or report for each MBS session. Alternatively, like in Operation 2, the AS layer of the UE itself may filter the measurement report for each MBS session and may or may not transfer (discard) the measurement report to the NG-RAN.

According to an embodiment, the OAM may transmit APP layer QoE configuration information (for example, measConfigAppLayerContainer) including the indicator (for example, mbs-SessionList) indicating whether QoE measurement for each MBS session is performed to the UE. When the OAM generates APP layer QoE configuration information for the MBS service, the OAM may include the indicator indicating whether QoE measurement for each MBS session is performed in the APP layer QoE configuration information. For example, the OAM may know the MBS session ID (TMGI or g-RNTI) (for example, through communication with an entity for the MBS service such as an MB-SMF), and activate or deactivate the QoE measurement or report for each MBS session ID when generating APP layer QoE configuration information for MBS. The APP layer of the UE receiving the APP layer QoE configuration information including the indicator indicating whether QoE measurement is performed may perform QoE measurement or generate a report only for an MBS session indicated to be activated. Further, the APP layer of the UE may not perform QoE measurement or not generate or transmit the report for an MBS session indicated to be deactivated.

When the APP layer of the UE generates the QoE measurement result report and transfers the same to the AS layer of the UE, the APP layer may also transmit the TMGI or the g-RNTI for each QoE report in order to indicate the MBS session for which the report is performed. At this time, the conventional AT-command or a new AT-command may be used. When transmitting the QoE measurement result report to the NG-RAN through the MeasurementReportAppLayer message, the AS layer of the UE receiving the TMGI or the g-RNTI may include the received TMGI or g-RNTI in the QoE measurement result report and transmit the same as shown below.

TABLE 22

[symbol]

[symbol]

indicates data missing or illegible when filed

When at least one of the following conditions is met, the UE may include the TMGI or the g-RNTI in MeasurementReportAppLayer-r17-IEs.
The case where the UE supports the QoE measurement or report
The case where the UE supports the QoE measurement or report for the MBS
The case where the UE supports the QoE measurement or report for each MBS session
The case where serviceType of MeasurementReportAppLayer-r17-IEs is the MBS or MBS broadcast
The case where the NG-RAN supports the QoE measurement or configuration for each MBS session
The case where the NG-RAN supports the QoE measurement or configuration for the MBS
The case where the NG-RAN allows QoE measurement for each MBS session

QoE measurement result reports for a plurality of MBS sessions (or at least one MBS session) may be included in one MeasurementReportAppLayer-r17-IEs. and a plurality of MBS session IDs (for example, TMGIs or g-RNTIs) (or at least one MBS session) corresponding thereto may be defined or included.

The AS layer of the UE may transmit the QoE measurement result report and report corresponding MBS session ID(s) (TMGI(s) or g-RNTI(s)) to the NG-RAN through the following messages rather than the measurementReport AppLayer message.
MBSInterestIndication
UEInformationResponse
UEAssistanceInformation

Unlike a method by which the AS layer indicates the MBS session ID (TMGI or g-RNTI) corresponding to each QoE measurement result report through the RRC parameter, the corresponding MBS session ID (TMGI or g-RNTI) may be defined and indicated within the APP layer QoE measurement result report (for example, measurementReportAppLayerContainer). QoE measurement result reports for a plurality of MBS sessions (or at least one MBS session) may be included in one APP layer QoE measurement result report (for example, measurementReportAppLayerContainer), or a plurality of MBS session Ids (for example, TMGIs or g-RNTIs) (or at least one MBS session ID) corresponding thereto may be defined or included.

The conventional QoE measurement was defined and used only for the unicast service (streaming. MTSI, or VR). However, if the MBS is introduced to the service type, an indicator for distinguishing between a QoE configuration (or report) for MBS multicast and a QoE configuration (or report) for MBS broadcast may be needed. According to an embodiment, in order to identify the QoE configuration (or report) for MBS multicast or the QoE configuration (or report) for MBS broadcast, a new indicator below may be used.

TABLE 23

[symbol]

[symbol]

indicates data missing or illegible when filed

When serviceType is the MBS, the NG-RAN may include an indicator (for example, serviceCategory) for identifying whether the MBS is for multicast or broadcast. Accordingly, the NG-RAN may indicate the QoE configuration for MBS multicast or the QoE configuration for MBS broadcast. When serviceType is the MBS but the indicator (for example, serviceCategory) is absent, it may mean QoE configurations for both the MBS multicast and the MBS broadcast. Alternatively, the indicator (for example, serviceCategory) may be defined as ENUMERATED {multicast, broadcast, both}, and may indicate, as “both”, the QoE configuration commonly applied to both the MBS multicast and the MBS broadcast. At this time, when the indicator (for example, serviceCategory) is absent, it may mean the QoE measurement configuration for the unicast service.

Alternatively, the indicator (for example, serviceCategory) may be defined as ENUMERATED {unicast, multicast, broadcast}, and may indicate unicast for service types that do not correspond to the MBS and indicate multicast or broadcast for the service type corresponding to the MBS.

The indicator (for example, serviceCategory) may be transferred up to the APP layer of the UE, and the APP layer of the UE may (or may not) perform QoE measurement for each cast, based thereon or may (or may not) generate the QoE measurement report. Accordingly, the QoE measurement report generated by the UE may also indicate which cast the QoE measurement result is for, as follows. Like the indicator for identifying the QoE configuration for MBS multicast configured by the NG-RAN or the QoE configuration for MBS broadcast, the indicator (for example, serviceCategory) for reporting QoE measurement may also be defined in various IE forms.

TABLE 24

[symbol]

[symbol]

indicates data missing or illegible when filed

The QoE measurement result report generated by the APP layer of the UE may be transferred to the AS layer of the UE and stored. The QoE measurement result report in the connected state, the inactive state, or the idle state of the UE may be stored in the AS layer. However, the size of memory for storing the QoE measurement result report in the AS layer may be limited. When the memory of the UE is full, if QoE measurement result reports are additionally generated and transferred to the AS layer, the AS layer of the UE may discard some QoE measurement reports or QoE measurement report corresponding to the exceeded size. To this end, the OAM, the CN, or the NG-RAN may configure a priority for storage of the QoE measurement reports along with the QoE configuration information as shown below.

TABLE 25

[symbol]

[symbol]

indicates data missing or illegible when filed

For example, it may be indicated whether a priority of the QoE measurement result report for the MBS service type is higher or lower than a priority of the QoE measurement result report for another service type (for example, mbsPriorityOverUnicast). The indicator (for example, mbsPriority OverUnicast) may be included when serviceType is the MBS. When the indicator (for example, mbsPriority OverUnicast) is absent, it may mean that priorities of all service types are the same. Alternatively, a priority may be indicated for each QoE configuration (for example, MeasConfigAppLayer) (for example, priority). When the memory of the UE is full, the UE may preferentially discard a report generated for a QoE measurement configuration having the lowest priority. In other words, the UE may discard a report generated for a QoE measurement configuration, based on a priority.

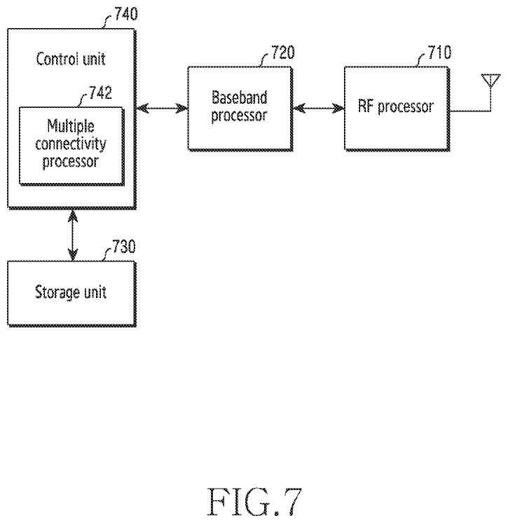

FIG. 7 illustrates an example of a functional configuration of the UE in a wireless communication system according to embodiments of the disclosure.

Referring to FIG. 7, the UE may include a radio frequency (RF) processing unit 710, a baseband processing unit 720, a storage unit 730, and a controller 740.

The RF processing unit 710 may perform a function for transmitting and receiving a signal through a radio channel such as band conversion and amplification of a signal. That is, the RF processing unit 710 may up-convert a baseband signal provided from the baseband processing unit 720 into an RF band signal and then transmit the RF band signal through an antenna. Further, the RF processing unit 710 may down-convert the RF band signal received through the antenna into the baseband signal and then transmit the baseband signal to the baseband processing unit 720. For example, the RF processing unit 710 may include a transmission filter, a reception filter, an amplifier, a mixer, an oscillator, a digital-to-analog convertor (DAC), an analog-to-digital convertor (ADC), and the like. Although not illustrated in FIG. 7, the UE may include a plurality of antennas (or antenna elements). Further, the RF processing unit 710 may include a plurality of RF chains. The plurality of RF chains may correspond to a plurality of antennas. The RF processing unit 710 may perform beamforming. For beamforming, the RF processing unit 710 may control a phase and a size of each of the signals transmitted and received through a plurality of antennas or antenna elements. Further, the RF processing unit 710 may perform MIMO and receive a plurality of layers when the MIMO operation is performed.

The baseband processor 720 may perform a function of conversion between a baseband signal and a bitstream according to a physical layer standard of the system. For example, in data transmission, the baseband processing unit 720 may generate complex symbols by encoding and modulating a transmission bitstream. In data reception, the baseband processing unit 720 may reconstruct a reception bitstream by demodulating and decoding the baseband signal provided from the RF processing unit 710. For example, in an orthogonal frequency division multiplexing (OFDM) scheme, when data is transmitted, the baseband processing unit 720 may encode and modulate a transmission bitstream to generate complex symbols, map the complex symbols to subcarriers, and then configure OFDM symbols through an inverse fast Fourier transform (IFFT) operation or a cyclic prefix (CP) insertion. Further, in data reception, the baseband processing unit 720 may divide the baseband signal provided from the RF processing unit 710 in units of OFDM symbols, reconstruct the signals mapped to the subcarriers through a fast Fourier transform (FFT) operation, and then reconstruct a reception bitstream through demodulation and decoding.

The baseband processing unit 720 and the RF processing unit 710 may transmit and receive the signal as described above. Accordingly, the baseband processing unit 720 and the RF processing unit 710 may be referred to as transmitters, receivers, transceivers, or communication units. At least one of the baseband processing unit 720 and the RF processing unit 710 may include a plurality of communication modules to support a plurality of different radio access technologies. At least one of the baseband processing unit 720 and the RF processing unit 710 may include different communication modules to process signals in different frequency bands. For example, the different radio access technologies may include a wireless LAN (for example, IEEE 802.11) and a cellular network (for example, LTE). Further, the different frequency bands may include a super high frequency (SHF) (for example, 2.NRHz. NRhz) band and a millimeter (mm) wave (for example, 60 GHz) band.

The storage unit 730 stores a basic program for the operation of the UE, an application program, and data such as configuration information. Particularly, the storage unit 730 may store information related to a second access node that performs wireless communication by using a second radio access technology. The storage unit 730 provides stored data in response to a request from the controller 740.

The controller 740 may control the overall operation of the UE. For example, the controller 740 may transmit and receive a signal through the baseband processing unit 720 and the RF processing unit 710. The controller 740 records data in the storage unit 740 and reads the same. To this end, the controller 740 may include at least one processor. For example, the controller 740 may include a communication processor (CP) that performs a control for communication, and an application processor (AP) that controls a higher layer such as an application program.

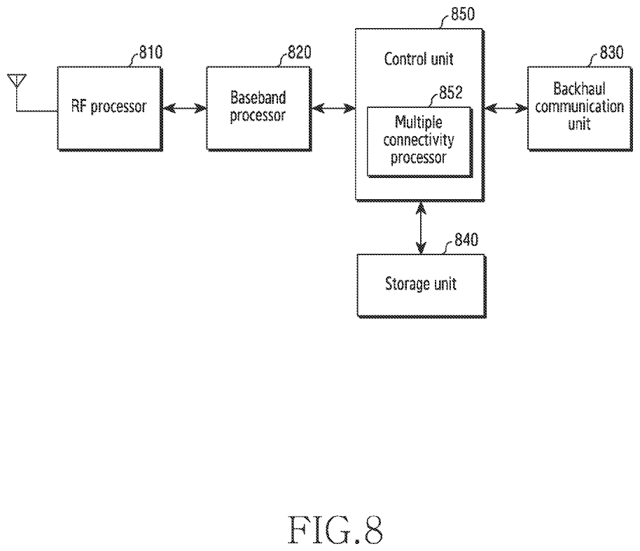

FIG. 8 illustrates an example of a configuration of the BS in a wireless communication system according to embodiments of the disclosure.

Referring to FIG. 8, the BS includes an RF processing unit 810, a baseband processing unit 820, a backhaul communication unit 830, a storage unit 840, and a controller 850.

The RF processing unit 810 may perform a function for transmitting and receiving a signal through a radio channel such as band conversion and amplification of a signal. That is, the RF processing unit 810 up-converts a baseband signal provided from the baseband processing unit 820 into an RF band signal, transmits the RF band signal through an antenna, and then down-converts the RF band signal received through the antenna into the baseband signal. For example, the RF processing unit 810 may include a transmission filter, a reception filter, an amplifier, a mixer, an oscillator, a DAC, and an ADC. Although FIG. 8 illustrates only one antenna, the BS may include a plurality of antennas (antenna elements). Further, the RF processing unit 810 may include a plurality of RF chains. The RF processing unit 810 may perform beamforming. For beamforming, the RF processing unit 810 may control a phase and a size of each of the signals transmitted and received through a plurality of antennas or antenna elements. The RF processing unit may perform a downlink MIMO operation by transmitting one or more layers.

The baseband processing unit 820 performs a function of conversion between the baseband signal and the bitstream according to the physical layer standard. For example, in data transmission, the baseband processing unit 820 may generate complex symbols by encoding and modulating a transmission bitstream. In data reception, the baseband processing unit 820 may reconstruct a reception bitstream by demodulating and decoding the baseband signal provided from the RF processing unit 810. For example, in an OFDM scheme, when data is transmitted, the baseband processing unit 820 may encode and modulate the transmission bitstream to generate complex symbols, map the complex symbols to subcarriers, and then configure OFDM symbols through an IFFT operation and CP insertion. In addition, when data is received, the baseband processing unit 820 may divide the baseband signal provided from the RF processing unit 810 in units of OFDM symbols, reconstruct signals mapped to subcarriers through an FFT operation, and then reconstruct a reception bitstream through demodulation and decoding. The baseband processing unit 820 and the RF processing unit 810 may transmit and receive the signal as described above. Accordingly, the baseband processing unit 820 and the RF processing unit 810 may be referred to as transmitters, receivers, transceivers, communication units, or wireless communication units.

The backhaul communication unit 830 provides an interface for communicating with other nodes within the network. That is, the backhaul communication unit 830 converts a bitstream transmitted from a main BS to another node, for example, an auxiliary BS, a core network, or the like into a physical signal, and converts the physical signal received from the other node into the bitstream.

The storage unit 840 stores data such as the basic program for the operation of the main BS, an application program, and configuration information. Particularly, the storage unit 840 may store information on a bearer allocated to the accessed UE and a measurement result reported from the accessed UE. Further, the storage unit 840 may store information which is a reference for determining whether to provide multiple connections to the UE or stop the connections. The storage unit 840 provides stored data in response to a request from the controller 850.

The controller 850 controls the overall operation of the main BS. For example, the controller 850 transmits and receives a signal through the baseband processing unit 820 and the RF processing unit 810 or through the backhaul communication unit 830. The controller 850 records data in the storage unit 840 and reads the same. To this end, the controller 850 may include at least one processor.

According to various embodiments, a method performed by a user equipment (UE) for quality of experience (QoE) measurement in a wireless communication system may include an operation of receiving configuration information related to the QoE measurement for a multicast broadcast service (MBS), and an operation of performing the QoE measurement, based on the configuration information and an operation of transmitting a QoE measurement result report, based on the QoE measurement, and the configuration information related to the QoE measurement may include an indicator indicating whether the QoE measurement for each MBS session is supported.

In an embodiment, the configuration information related to the QoE measurement may be transmitted through a message broadcasted from a base station (BS) or a UE-dedicated message from the BS.

In an embodiment, the configuration information related to the QoE measurement may be included in configuration information transmitted from operations administration and maintenance (OAM) through the BS.

In an embodiment, the operation of performing the QoE measurement may include, when the indicator indicating whether the QoE measurement for each MBS session is supported is activated, performing the QoE measurement only for at least one MBS session or performing filtering such that the QoE measurement is performed for all MBS sessions and is reported only for the at least one MBS session.

In an embodiment, the at least one MBS session may be indicated by a temporary mobile group identity (TMGI) or a group-radio network temporary identifier (g-RNTI).

In an embodiment, in the method, the QoE measurement result report may include a temporary mobile group identity (TMGI) or a group-radio network temporary identifier (g-RNTI) indicating at least one MBS session.

In an embodiment, the configuration information may include information indicating whether an MBS related to the QoE measurement is for multicast or broadcast, and the QoE measurement result report may include information indicating whether an MBS related to a result of the QoE measurement is for multicast or broadcast.

According to various embodiments, a user equipment (UE) for quality or experience (QoE) measurement may include a transceiver and at least one processor coupled to the transceiver, the at least one processor may be configured to receive configuration information related to the QoE measurement for a multicast broadcast service (MBS), perform the QoE measurement, based on the configuration information, and transmit a QoE measurement result report, based on the QoE measurement, and the configuration information related to the QoE measurement may include an indicator indicating whether the QoE measurement for each MBS session is supported.

In an embodiment, the configuration information related to the QoE measurement may be transmitted through a message broadcasted from a base station (BS) or a UE-dedicated message from the BS.

In an embodiment, the configuration information related to the QoE measurement may be transmitted through configuration information transmitted from operations administration and maintenance (OAM) through the BS.

In an embodiment, the at least one processor may be configured to, when the indicator indicating whether the QoE measurement for each MBS session is supported is activated, perform the QoE measurement only for at least one MBS session or perform filtering such that the QoE measurement is performed for all MBS sessions and is reported only for the at least one MBS session.

In an embodiment, the at least one MBS session may be indicated by a temporary mobile group identity (TMGI) or a group-radio network temporary identifier (g-RNTI).

In an embodiment, the at least one processor may be further configured to generate the QoE measurement result report, and the QoE measurement result report may include a temporary mobile group identity (TMGI) or a group-radio network temporary identifier (g-RNTI).

In an embodiment, the configuration information may include information indicating whether an MBS related to the QoE measurement is for multicast or broadcast, and the QoE measurement result report may include information indicating whether an MBS related to a result of the QoE measurement is for multicast or broadcast.

According to various embodiments, a method performed by a base station (BS) for quality of experience (QoE) measurement in a wireless communication system may include an operation of transmitting configuration information related to the QoE measurement for a multicast broadcast service (MBS) and an operation of receiving a QoE measurement result report, and the configuration information related to the QoE measurement may include an indicator indicating whether the QoE measurement for each MBS session is supported.

In an embodiment, the configuration information related to the QoE measurement may be transmitted through a message broadcasted from BS or a UE-dedicated message from the BS.

In an embodiment, the configuration information related to the QoE measurement may be transmitted through configuration information transmitted from operations administration and maintenance (OAM) through the BS.

In an embodiment, the method may further include transmitting a temporary mobile group identity (TMGI) or a group-radio network temporary identifier (g-RNTI).

In an embodiment, the QoE measurement result report may include a temporary mobile group identity (TMGI) or a group-radio network temporary identifier (g-RNTI).

In an embodiment, the configuration information may include information indicating whether an MBS related to the QoE measurement is for multicast or broadcast, and the QoE measurement result report may include information indicating whether an MBS related to a result of the QoE measurement is for multicast or broadcast.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet. Local Area Network (LAN). Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A method performed by a user equipment (UE) for quality of experience (QoE) measurement in a wireless communication system, the method comprising:
receiving configuration information related to the QoE measurement for a multicast broadcast service (MBS);
performing the QoE measurement, based on the configuration information; and
transmitting a QoE measurement result report, based on the QoE measurement,
wherein the configuration information related to the QoE measurement comprises an indicator indicating whether the QoE measurement for each MBS session is supported.

2. The method of claim 1, wherein the configuration information related to the QoE measurement is transmitted through a message broadcasted from a base station (BS) or a UE-dedicated message from the BS.

3. A user equipment (UE) for quality or experience (QoE) measurement in a wireless communication system, the UE comprising:
a transceiver; and
at least one processor coupled to the transceiver,
wherein the at least one processor is configured to:
receive configuration information related to the QoE measurement for a multicast broadcast service (MBS);
perform the QoE measurement, based on the configuration information; and
transmit a QoE measurement result report, based on the QoE measurement, and
wherein the configuration information related to the QoE measurement comprises an indicator indicating whether the QoE measurement for each MBS session is supported.

4. The UE of claim 3, wherein the configuration information related to the QoE measurement is transmitted through a message broadcasted from a base station (BS) or a UE-dedicated message from the BS.

5. The UE of claim 3, wherein the configuration information related to the QoE measurement is configuration information transmitted from operations administration and maintenance (OAM) through a base station (BS).

6. The UE of claim 3, wherein the at least one processor is configured to:
in case that the indicator indicating whether the QoE measurement for each MBS session is supported is activated,
perform the QoE measurement only for at least one MBS session; or
perform filtering such that the QoE measurement is performed for all MBS sessions and is reported only for the at least one MBS session.

7. The UE of claim 6, wherein the at least one MBS session is indicated by a temporary mobile group identity (TMGI) or a group-radio network temporary identifier (g-RNTI).

8. The UE of claim 3, wherein the QoE measurement result report comprises a temporary mobile group identity (TMGI) or a group-radio network temporary identifier (g-RNTI) indicating at least one MBS session.

9. The UE of claim 3, wherein the configuration information comprises information indicating whether an MBS related to the QoE measurement is for multicast or broadcast, and
wherein the QoE measurement result report comprises information indicating whether an MBS related to a result of the QoE measurement is for multicast or broadcast.

10. A method performed by a base station (BS) for quality of experience (QoE) measurement in a wireless communication system, the method comprising:
transmitting configuration information related to the QoE measurement for a multicast broadcast service (MBS); and
receiving a QoE measurement result report,
wherein the configuration information related to the QoE measurement comprises an indicator indicating whether the QoE measurement for each MBS session is supported.

11. The method of claim 10, wherein the configuration information related to the QoE measurement is transmitted through a message broadcasted from BS or a UE-dedicated message from the BS.

12. The method of claim 10, wherein the configuration information related to the QoE measurement is configuration information received from operations administration and maintenance (OAM).

13. The method of claim 10, further comprising transmitting a temporary mobile group identity (TMGI) or a group-radio network temporary identifier (g-RNTI).

14. The method of claim 10, wherein the QoE measurement result report comprises a temporary mobile group identity (TMGI) or a group-radio network temporary identifier (g-RNTI) indicating at least one MBS session.

15. The method of claim 10, wherein the configuration information comprises information indicating whether an MBS related to the QoE measurement is for multicast or broadcast, and
wherein the QoE measurement result report comprises information indicating whether an MBS related to a result of the QoE measurement is for multicast or broadcast.
